(19) United States
(12) Patent Application Publication
(10) Pub. No.: US 2025/0289717 A1
(43) Pub. Date: Sep. 18, 2025

(54) Method For Determining Mixing Parameters For The Preparation Of A Phosphoric Acid Solution Comprising A Controlled Content Of One Or More Of Its Constituents

(71) Applicants: OCP SA, Casablanca (MA); Universite Mohammed VI Polytechnique, Benguerir (MA)

(72) Inventors: Khaoula Khaless, El Jadida (MA); Anass Hafnaoui, Tamaris Dar Bouazza (MA); Rachid Boulif, El Jadida (MA)

(73) Assignees: OCP SA, Casablanca (MA); Universite Mohammed VI Polytechnique, Benguerir (MA)

(21) Appl. No.: 18/265,837

(22) PCT Filed: Dec. 8, 2021
(86) PCT No.: PCT/MA2021/050019

§ 371 Date: Feb. 20, 2024

(30) Foreign Application Priority Data
Dec. 9, 2020 (FR) 2012902

(51) Int. Cl. C01B 25/234; B01D 61/02; B01F 35/22; B01F 101/00

(52) U.S. Cl. CPC C01B 25/234; B01D 61/0271; B01F 35/2203; B01D 2317/025; B01D 2317/06; B01F 2101/2204; C01P 2006/80

(57) ABSTRACT

A method for determining mixing parameters for preparing a phosphoric acid solution having a controlled content of at least one of its chemical constituents, by mixing at least two phosphoric acid solutions, each having a different content of the chemical constituent, of which at least one is a permeate resulting from the filtration of a crude phosphoric acid solution through at least one nanofiltration membrane. The method includes: (1) providing a desired content (Tm) of the chemical constituent in the phosphoric acid solution to be prepared, and a desired volume (Vm) of the phosphoric acid solution to be prepared; (2) determining, using a computer, on the basis of the desired content (Tm) and the desired volume (Vm): at least one combination of at least two phosphoric acid solutions among the phosphoric acid solutions to be mixed; volumes of each of the phosphoric acid solutions to be mixed of the combination, such that the mixing of the phosphoric acid solutions of the combination leads to the phosphoric acid solution to be prepared.

### TECHNICAL FIELD OF THE INVENTION

The present invention relates to a method for determining the mixing parameters for the preparation of a phosphoric acid solution comprising a controlled content of one or more of its constituents.

### STATE OF THE ART

Phosphoric acid can be manufactured by thermal or wet process.

Wet process phosphoric acid is industrially obtained in the form of a solution by attacking natural phosphate with a strong acid such as hydrochloric acid, nitric acid and/or sulphuric acid.

This is the most widespread manufacturing technique, especially for its greater simplicity of implementation. However, it has the disadvantage of providing a phosphoric acid loaded with impurities, especially Fe, Al, Cd, Cu, Zn, Pb, and U. These impurities can be troublesome depending on the intended use of the phosphoric acid thus prepared, which leads to the need to carry out purification operations of the crude acid in order to remove impurities, and especially cadmium.

Cadmium has been the subject of several studies to improve its extraction from crude phosphoric acid. These studies involve extraction processes by solvent, by ion exchange on resins, by precipitation, or by ionic flotation. However, the chemical aggressiveness of the phosphoric medium and the high cost of these methods constitute major obstacles to their industrialisation.

Membrane filtration methods, referred to as membrane methods, have proven to be capable of providing finished products with high added value, especially by means of the selectivity of the membranes.

Membrane methods are classified according to pore size, cutoff threshold and hydraulic permeability of the membranes at 25° C.

In the field of drinking water: Microfiltration is an almost total barrier for suspended matter and bacteria.

Ultrafiltration allows not only removing impurities but also several types of microorganisms.

Reverse osmosis is able to remove monovalent ions in addition to other impurities.

Nanofiltration covers an area between reverse osmosis and ultrafiltration. It is effective in removing impurities such as cadmium, as well as multivalent ions.

The applicant has conducted several filtration studies of phosphoric acid by membrane methods, on unmodified commercial membranes and commercial membranes modified by adsorption of different polymers. These membranes are the subject of document WO 2013/133684.

These studies allowed the applicant to conclude that the use of modified nanofiltration membranes greatly improves the retention of impurities, in particular that of metallic impurities. In return, it seems difficult to preferentially retain one particular impurity with regard to another. In other words, the methods for purifying phosphoric acid by nanofiltration membrane do not have sufficient selectivity to allow the preparation of a purified phosphoric acid solution whose contents of certain determined metallic impurities correspond to theoretical contents chosen beforehand.

This low selectivity of nanofiltration membranes with regard to the metallic impurities of phosphoric acid can be an economic impediment to decadmiation, i.e., the removal of cadmium, by a membrane method. Several industrial sectors are concerned, in particular the fertilisers sector, which requires specific acid qualities which have optimal contents of certain metallic impurities, such as iron or magnesium, for example, as well as particular concentrations of P₂O₅.

### BRIEF DESCRIPTION OF THE INVENTION

One objective of the invention is to overcome the above disadvantages.

The invention especially seeks to provide a method for determining the mixing parameters for the preparation of a phosphoric acid solution, making it possible to produce a phosphoric acid solution having a controlled content of one or more of its chemical constituents, especially P₂O₅ and cadmium.

The invention especially seeks to provide such a method, which is simple and rapid to implement, while reducing the quantities of effluents harmful to the environment.

To this end, the invention proposes a method for determining mixing parameters for the preparation of a phosphoric acid solution comprising a controlled content of at least one of its chemical constituents, referred to as the solution to be prepared, said solution to be prepared being obtained by mixing at least two phosphoric acid solutions, referred to as solutions to be mixed, each having a different content of said chemical constituent, at least one of which is a permeate resulting from the filtration of a crude phosphoric acid solution through at least one nanofiltration membrane, said method being characterised in that it comprises the following steps:
(1) providing a desired content (Tₘ) of said chemical constituent in the phosphoric acid solution to be prepared, and a desired volume (Vₘ) of said phosphoric acid solution to be prepared;
(2) determining using a computer, from the desired content (Tₘ) and the desired volume (Vₘ):
   at least one combination of at least two phosphoric acid solutions among the phosphoric acid solutions to be mixed;
   volumes of each of said phosphoric acid solutions to be mixed of the combination, such that the mixing of the phosphoric acid solutions of the combination leads to the phosphoric acid solution to be prepared.

In the present text, “a filtration cascade” corresponds to an arrangement of several nanofiltration membranes in which the membranes are positioned one after the other to carry out several successive filtrations of the starting phosphoric acid solution. In a nanofiltration cascade, the permeate of one membrane corresponds to the starting solution, before filtration, of the next membrane.

According to optional but advantageous characteristics, possibly taken in combination:
the method also includes the provision of the desired volume of at least one phosphoric acid solution to be mixed, separate from the solution to be prepared, the computer determination of the combination of phosphoric acid solutions to be mixed and their volume being made from said desired volume of said phosphoric acid solution;
the method also comprises a step of mixing the solutions of the computer-determined combination to obtain the phosphoric acid solution to be prepared;
the mixing step of the phosphoric acid solutions to be mixed comprises the mixing of at least three phosphoric acid solutions, at least two of which are permeates resulting from the filtration of the crude phosphoric acid solution through at least two nanofiltration membranes of a filtration cascade;
the method further comprises a step of measuring a content (T) of said chemical constituent in the phosphoric acid solution to be prepared and the volume (V) of said phosphoric acid solution to be prepared;
said chemical constituent is selected from one or more of the following chemical constituents: P₂O₅, Cd, Na, Ca, Mg, Al, Cu, Fe, Zn, Mn, Si, Co, V, Ni and Cr;
at least one nanofiltration membrane is an organic membrane on which is adsorbed at least one water-soluble polymer comprising at least one amine function, one aromatic amine function, one acid function and/or one alcohol function;
the adsorbed water-soluble polymer has a molar mass comprised between 100 g/mol and 40,000 g/mol.

Another objective of the invention concerns a system for determining mixing parameters for the preparation of a phosphoric acid solution comprising a controlled content of at least one of its chemical constituents, referred to as the solution to be prepared, said solution to be prepared being obtained by mixing at least two phosphoric acid solutions, referred to as solutions to be mixed, each having a different content of said chemical constituent, at least one of which is a permeate resulting from the filtration of a crude phosphoric acid solution through at least one nanofiltration membrane, comprising:
a user interface;
a computer comprising at least one processor, coupled to said user interface, the user interface being configured to allow a user to enter a desired content (Tₘ) of said chemical constituent in the phosphoric acid solution to be prepared, and a desired volume (Vₘ) of said phosphoric acid solution to be prepared, the computer being configured, from the desired content (Tₘ) and the desired volume (Vₘ), to determine:
at least one combination of at least two phosphoric acid solutions among the phosphoric acid solutions to be mixed;
volumes of each of said phosphoric acid solutions to be mixed of the combination, such that the mixing of the phosphoric acid solutions of the combination leads to the phosphoric acid solution to be prepared, the user interface being further configured to display said combination and said volumes to be mixed as determined by the computer.

### DESCRIPTION OF THE FIGURES

Other advantages and characteristics of the invention will become apparent on reading the following description given by way of illustrative and non-limiting example, in reference to the following attached figures:

FIG. 1 is a diagram illustrating the preparation of different phosphoric acid solutions by serial nanofiltration.

FIG. 2 is a diagram illustrating the preparation of different phosphoric acid solutions by serial nanofiltration according to FIG. 1, as well as the mixing thereof to obtain a phosphoric acid solution to be prepared.

FIG. 3 is a diagram illustrating the preparation of different phosphoric acid solutions by serial nanofiltration according to FIG. 2, as well as the computer acquisition of the volumes of these solutions and the contents of one or more of their chemical constituents.

FIG. 4 illustrates a user interface, which shows a combination of several phosphoric acid solutions of different qualities, intended to be mixed to make a final solution whose volume, P₂O₅ content and cadmium content are predetermined, according to a first embodiment.

FIG. 5 illustrates a user interface similar to that of FIG. 4, according to a second embodiment.

FIG. 6 illustrates a user interface similar to that of FIGS. 4 and 5, according to a third embodiment.

### DETAILED DESCRIPTION OF EMBODIMENTS OF THE INVENTION

The invention concerns a method for determining the mixing parameters for the preparation of a phosphoric acid solution comprising a controlled content of at least one of its chemical constituents.

The chemical constituent whose content is controlled, also referred to as the chemical constituent of interest, may be the mass content of phosphorus pentoxide or phosphoric anhydride (% P₂O₅) and/or the mass content of the following chemical elements considered to be impurities: Cd, Na, Ca, Mg, Al, Cu, Fe, Zn, Mn, Si, Co, V, Ni and Cr.

The invention is based on a method for purifying a phosphoric acid solution comprising at least one step of filtering phosphoric acid by a nanofiltration membrane. Several steps of filtration of the phosphoric acid solution can be carried out consecutively, especially two, three, or four steps, with several filtration membranes of chemical structures that are identical or different to each other.

According to a preferred embodiment, the nanofiltration membrane is an organic membrane on which is adsorbed at least one water-soluble polymer comprising at least one amine function, one aromatic amine function, one acid function and/or one alcohol function.

Preferably, the adsorbed water-soluble polymer has a molar mass comprised between 100 g/mol and 40,000 g/mol.

For this filtration step, the phosphoric acid solution is circulated over a membrane, preferably tangentially to said membrane. Starting from a volume V0 of crude phosphoric acid solution, a purified phosphoric acid permeate is collected whose volume is a fraction y*V0 of the initial volume V0. The coefficient y is generally comprised between 0.4 and 0.8, advantageously comprised between 0.6 and 0.8.

Preferably, the concentration of phosphoric acid in the solution is comprised between 10 and 45% P₂O₅, preferably between 25 and 30% P₂O₅.

The method according to the invention can be used for any solution of phosphoric acid, whatever its origin.

The phosphoric acid in solution is advantageously wet process phosphoric acid obtained by the action of a strong acid, such as hydrochloric acid, nitric acid and/or sulphuric acid on the natural phosphate. The phosphoric acid obtained in solution is then purified by nanofiltration.

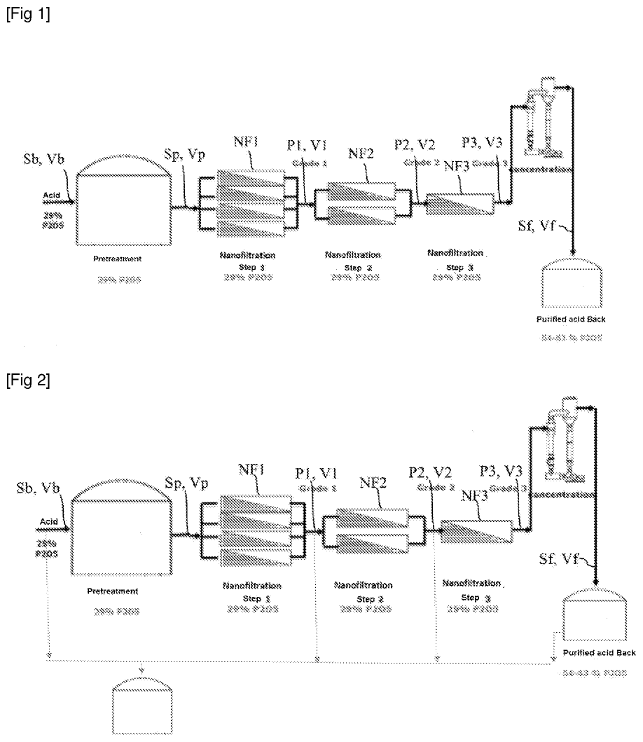

The steps of the method for purifying a phosphoric acid solution by nanofiltration membrane filtration are illustrated in FIG. 1.

According to an optional but advantageous first step, the method comprises a first step of pretreatment of the crude phosphoric acid solution Sb of volume Vb so as to remove from it both the solids and the organic matter, which would be liable to irreversibly clog the nanofiltration membranes used subsequently.

This usual step of a method for the preparation and purification of phosphoric acid is well known to the person skilled in the art, and may especially include clarification with a view to obtaining an absorbance at 408 nm of less than 0.3 and a reduced content of solid particles.

At the end of the pretreatment, the pretreated phosphoric acid solution Sp of volume Vp which will then be purified has a solid particle content of less than 1%, preferably less than or equal to 0.7%, and an organic carbon content of less than 1000 ppm, preferably less than or equal to 300 ppm.

By means of this pre-treatment, the service life and efficiency of the nanofiltration membranes used for purification are significantly improved.

The phosphoric acid solution thus treated is then subjected to one or more successive membrane filtration steps.

Starting from the volume of pretreated phosphoric acid solution Sp, or crude phosphoric acid Sb if no pretreatment is carried out, a first permeate P1 of purified phosphoric acid is collected after filtration on the membrane NF1, the volume V1 of which is a fraction y1*Vp of the volume Vp.

The coefficient y1 is advantageously comprised between 0.6 and 0.8.

According to a second filtration step, the first permeate P1 is circulated over a membrane NF2, preferably tangentially to said membrane.

The membrane NF2 used in the second step may be the same as the membrane NF1 used in the first step or may be a different membrane but having a similar chemical structure.

A second permeate P2 of purified phosphoric acid is thus collected, the volume V2 of which is a fraction y2*Vp of the volume Vp.

The coefficient y2 is typically comprised between 0.4 and 0.8.

According to a third filtration step, the first permeate P2 is circulated over a membrane NF3, preferably tangentially to said membrane.

The membrane NF3 used in the third step may be the same as the membrane NF1 used in the first step or the membrane NF2 used in the second step, or may be a different membrane but having a similar chemical structure.

A third permeate P3 of purified phosphoric acid is thus collected, the volume V3 of which is a fraction y3*Vp of the volume Vp.

The coefficient y3 is typically comprised between 0.3 and 0.8.

The third permeate is then concentrated via a concentration system SC suitable for this purpose, in order to obtain a final solution Sf of concentrated phosphoric acid of volume Vf, whose content by mass of P₂O₅ is greater than that of the third permeate P3.

The purified phosphoric acid can then be exploited, depending on its content, either as a food acid or as the result of an intermediate purification step, before finishing treatments (for example, liquid-liquid extraction).

The third permeate P3 is characterised by a content of one or more specific chemical constituents, especially impurities, lower than that of the second permeate P2, which itself has a content of said chemical constituent lower than that of the first permeate P1, which itself has a lower content of said chemical constituent than that of the initial phosphoric acid solution.

This chemical constituent is most particularly cadmium.

The crude phosphoric acid solution Sb, the pretreated solution Sp, the solutions P1, P2 and P3 obtained at the end of each filtration step, and the final solution Sf obtained after the concentration step each have a different grade, i.e., a different content T of chemical constituent of interest.

The method for determining the mixing parameters according to the invention makes it possible to prepare a phosphoric acid solution comprising a controlled content of at least one of its chemical constituents, preferably P₂O₅ and/or cadmium.

The method of the invention provides a customised volume and grade of phosphoric acid from the mixture of at least two of the phosphoric acid solutions of different qualities obtained in each step of the nanofiltration membrane purification method described above, i.e., from at least two solutions among: the crude phosphoric acid solution Sb, the pretreated solution Sp, the solutions P1, P2 and P3 obtained at the end of each filtration step, as well as the final solution Sf obtained after the concentration step.

More precisely, the method of the invention comprises a first step consisting of providing a desired content T_{S} of said chemical constituent in the phosphoric acid solution to be prepared Sm, as well as a desired volume V_{S} of said phosphoric acid solution to be prepared.

Starting from the desired content T_{S} and the desired volume V_{S} of the solution to be prepared, a second step of the method consists of determining:
at least one combination of at least two solutions of phosphoric acid among the solutions of phosphoric acid of different qualities, referred to as solutions to be mixed. In reference to FIG. 2, each solution that may be included in the combination is represented by an arrow. The arrows meet to lead to the phosphoric acid solution to be prepared Sm;
volumes of each of said phosphoric acid solutions to be mixed of the combination, such that the mixing of the phosphoric acid solutions of the combination leads to the phosphoric acid solution to be prepared Sm.

The solutions of the determined combination can then be mixed to obtain the phosphoric acid solution to be prepared.

Preferably, the number of membrane filtration steps is greater than or equal to 3, preferably greater than or equal to 4, and more preferably greater than or equal to 5. A high number of filtration steps allows obtaining more phosphoric acid solutions of different qualities which can be combined, which makes it possible, on the one hand, to maximise the efficiency of removal of the chemical constituent(s) of interest, especially in the case of impurities, and, on the other hand, to maximise the customised adjustment of the grade of the phosphoric acid solution to be prepared since the different filtration steps have different removal efficiencies from one another.

The determination of the combinations of the solutions to be mixed and their respective volumes requires relatively long and tedious calculations, which can be a source of errors.

This includes writing and solving systems of several equations with several unknowns for each mixing test one wishes to perform, i.e., each combination of phosphoric acid solutions envisaged.

An example of calculations is given in Example 3 below in this text.

Therefore, the invention also relates to a method for determining the mixing parameters for the preparation of a phosphoric acid solution as described above, in which the step of determining the combinations of phosphoric acid solutions to be mixed and the volumes of each of said solutions is performed by a computer.

The computer includes a computing device for performing the necessary calculations, a processor configured to communicate with the computing device for transmitting instructions to the computing device on calculations to be performed, and for receiving the results of the calculations from the computing device.

The computer also includes a user interface configured to communicate with the processor. The user interface allows the user to interact with the computer, in order to enter instructions and receive information on the progress and results of the execution of these instructions. To this end, the user interface preferably comprises a screen, which may advantageously be touch-sensitive, and optionally a keyboard and/or a pointing device (mouse).

The computer further comprises a memory to store the information that it receives and to record the algorithms implemented by the processor.

The user enters into the computer via the user interface the values of different physicochemical parameters concerning the solutions of different qualities of the filtration system. These parameters comprise, for each solution, the content of at least one of its chemical constituents, such as its content of: P₂O₅, Cd, Na, Ca, Mg, Al, Cu, Fe, Zn, Mn, Si, Co, V, Ni and Cr. The parameters may also include the temperature and density of the solution.

The user enters a desired volume for the phosphoric acid solution to be prepared and a desired content of one or more chemical constituents in said phosphoric acid solution to be prepared. The chemical constituent is preferably selected from: P₂O₅, Cd, Na, Ca, Mg, Al, Cu, Fe, Zn, Mn, Si, Co, V, Ni and Cr.

According to a preferred embodiment, the user also enters a desired volume of one or more solutions to be mixed. In this case, the combinations of solutions to be mixed determined by the computer include solutions whose volume has been set by the user.

The computer then determines all the combinations of phosphoric acid solutions to be mixed, as well as the volumes of each of the solutions of each combination, such that the mixing of the phosphoric acid solutions of each combination leads to the phosphoric acid solution to be prepared.

To do this, the computer transcribes the user instructions, including volumes, contents, and possibly other physicochemical parameters of the solutions to be mixed and the solution to be prepared, in the form of equation systems.

The equation systems are solved by the computing device, and the results are transmitted to the processor.

The processor processes the results that it received by selecting the physically consistent results.

The processor sends the selected results, comprising the selected combinations of phosphoric acid solutions and the volumes of each of the solutions of each combination, to the user interface.

The user interface preferably comprises visual indicators, preferably color indicators, allowing the user to visually observe:
that a solution has been selected in the combination for the manufacture of the phosphoric acid solution;
that the volume of this selected solution has a positive value.

If these two conditions are met, the visual indicator will inform the user accordingly, in particular by taking on a specific color. Otherwise, the indicator will inform the user that these conditions are not met.

The indicator can be provided to render different indications in the case where neither condition is met and in the case where only the first condition is met. For example, if a solution is not selected, the indicator takes a first color, while if the solution is selected but the calculated volume has a negative value, the indicator takes a second color.

The user can then choose a combination among those selected and produce the solution to be prepared by mixing the solutions of the combination according to the volumes indicated on the screen.

### EXAMPLES

### Example 1: Determination of a Combination of Phosphoric Acid Solutions to be Mixed and their Volumes for the Preparation of a Phosphoric Acid Solution Having a Controlled Content of P₂O₅ and Cd

An acid solution having a P₂O₅ content of 29% is filtered on three successive nanofiltration membranes of the same chemical structure, according to a discontinuous fed-batch process of the type shown in FIG. 1. The membrane used for the first step has a cut-off threshold of 1000 g·mol⁻¹, and the membranes used for the second and third steps have a cut-off threshold of 300 g·mol⁻¹. In a known manner, the molecules contained in phosphoric acid whose molar mass is greater than the membrane cutoff threshold are retained by the membrane.

For the first filtration, the NF270 type nanofiltration membrane is capable of filtering phosphoric acid and retaining, by an exclusion mechanism, multivalent impurities, especially Fe, Al, Cr and V, up to 65% of the total value of said impurities.

The tests show the following performance:
the retention rate of iron, aluminum and chromium is greater than 65%;
the retention rate of cadmium is 35%;
the retention of fluorine is 10%.

These results show that fluorine participates significantly in the electroneutrality of the retentate and that of the permeate.

For the second filtration, the following trivalent and divalent metallic impurities were strongly retained by the membrane:
the retention rate of iron, aluminum and chromium is greater than 85%;
the retention rate of cadmium is 72%;
the retention rate of fluorine is 5%.

These results confirm that fluorine participates significantly in the electroneutrality of the retentate and that of the permeate.

For the third filtration, the retention, or reduction, of metallic and non-metallic impurities is close to that of the second filtration. Therefore, it can be concluded that the cut-off threshold of impurities affects the reduction.

The assessment of the three filtration stages leads to a reduction of greater than 99% for the predominant impurities in the starting solution and greater than 90% for the minor impurities in the starting solution, and greater than 80% for non-metallic impurities such as fluorine, for example.

The results of the analysis of the different phosphoric acid solutions of different qualities obtained during the successive filtration steps are listed in Table 1 below.

TABLE 1

| | | Crude | | | | Final |
|---|---|---|---|---|---|---|
| Impurities | Unit | PA | P1 | P2 | P3 | product |
| P₂O₅ | % | 26.89 | 26.36 | 26.21 | 26 | 54.3 to 61.9 |
| Na | % | 0.1 | 0.06 | 0.06 | 0.03 | <200 |
| Ca | ppm | 0.22 | | 0.04 | 0.02 | <1 |
| Mg | % | 0.43 | 0.15 | 0.03 | 0.004 | <1 |
| Al | ppm | 0.55 | 0.20 | 0.03 | 0.003 | <1 |
| Cu | ppm | 33 | | 4 | 1 | <1 |
| Fe | % | 0.31 | 0.10 | 0.02 | 0.001 | <5 |
| Zn | ppm | 299 | 201 | 34 | <5 | <5 |
| Mn | ppm | 15 | | 2 | 0.2 | <0.5 |
| Si | % | 17 | | 0.76 | 0.34 | <1 |
| Co | ppm | 0.6 | 0.2 | 0.06 | <1 | <1 |
| V | ppm | 227 | 187 | 22 | 1 | <1 |
| Ni | ppm | 52 | 121 | 4 | <1 | <1 |
| Cr | ppm | 257 | 84 | 12 | 1 | <1 |
| Cd | ppm | 17 | 11 | 3 | 1 | <0.2 |

### Table 1: Chemical Characteristics of Phosphoric Acid Solutions Obtained During the Filtration Process

From the different solutions of phosphoric acid of different qualities obtained during successive filtration steps, having P₂O₅ contents comprised between 26% and 61.9% and cadmium contents comprised between approximately 1 ppm and 17 ppm (Table 1), it is envisaged to prepare 10 L of a phosphoric acid solution having a P₂O₅ content of 42% and a cadmium content of 7 ppm.

The volume of 10 L, the P₂O₅ content of 42% and the cadmium content of 7 ppm of the solution to be prepared correspond to industrial requirements depending on the subsequent applications envisaged.

The computer application according to the invention determines the phosphoric acid solutions to be combined as well as their volume, in order to prepare the desired phosphoric acid solution.

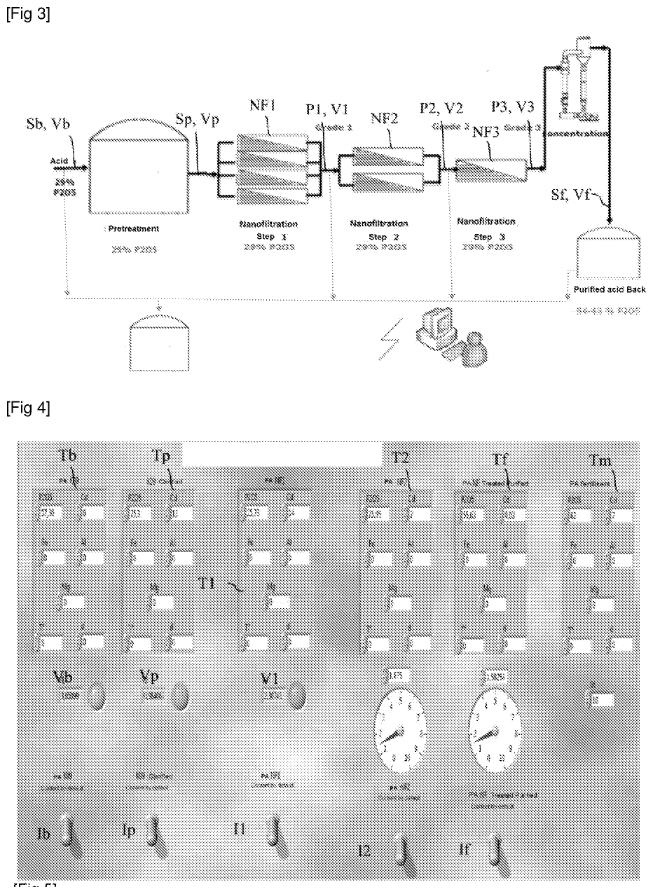

FIG. 4 shows a view of the user interface.

In this figure, tables Tb, Tp, T1, T2, Tf, and Tm in the upper part of the figure represent the contents of several chemical constituents: P₂O₅, Cd, Fe, Al, and Mg, in each of the phosphoric acid solutions of different qualities, referred to as solutions to be mixed, obtained during the successive filtration steps, respectively Sb, Sp, P1, P2, Sf, and Sm.

It is possible to provide an additional table corresponding to the permeate P3 obtained directly after the third filtration step, such a table not being shown in FIG. 4.

The values of the chemical constituents in each of the tables are entered by the user. Sliders are provided for this purpose.

The values given in tables Tb, Tp, T1 and T2 of the intermediate solutions correspond to the data available to the user, especially through chemical analyses of the solutions obtained in the process.

In FIG. 4, the user entered:
a P₂O₅ content of 57.36% and a Cd content of 6 ppm in Table Tb;
a P₂O₅ content of 25.3% and a Cd content of 13 ppm in Table Tp;
a P₂O₅ content of 25.73% and a Cd content of 14 ppm in Table T1;
a P₂O₅ content of 25.95% and a Cd content of 2 ppm in Table T2;
a P₂O₅ content of 55.63% and a Cd content of 0.03 ppm in Table Tf;
a desired P₂O₅ content of 42% and a desired Cd content of 7 ppm, in Table Tm.

The Fe, Al, and Mg contents are zero in all the tables because they were not entered by the user in tables Tb, Tp, T1, T2, and Tf, and the user does not want the solution to be prepared to have a particular content of these constituents and does not want the mixing of the various solutions to be carried out on the basis of these particular contents.

The values given in table Tf of the solution to be prepared correspond to the values desired by the user for the solution to be prepared.

Below each of the tables Tb, Tp, T1, T2, Tf, and Tm, boxes contain the volumes of each of the intermediate phosphoric acid solutions Sb, Sp, P1, P2, Sf, and the solution to be prepared Sm, for a given combination. These volumes are denoted respectively Vb, Vp, V1, V2, Vf, and Vm.

As described previously, the volume Vm is chosen beforehand by the user, who enters its value in the corresponding box. Some or all of the volumes Vb, Vp, V1, V2, and Vf are determined by the application based on the volume Vm.

In the example of FIG. 4, the user chooses the volume Vm and can also choose, if desired, the volumes of the solutions P2 and Sf to be used for the solution to be prepared using sliders provided for this purpose next to the frames located under the corresponding tables T2 and Tf.

Each needle dial below said frames indicates the same value as the corresponding frame above. The dials provide the user with an alternative visual rendering of the volume indicated in the frames in order to simplify the reading thereof.

In FIG. 4, the volumes V2 and Vf have a value of 1.475 L (litres) and 1.58254 L, respectively.

The volumes of the solutions Sb, Sp, and P1 are determined by the computer, and are indicated in the frames below the corresponding tables Tb, Tp, and T1. Unlike volumes V2, and Vf, volumes Vb, VP, and V1 cannot be adjusted by the user. Instead of the sliders, there are color indicators, allowing the user to visually observe:
that a solution has been selected in the combination for the manufacture of the phosphoric acid solution;
that the volume of this selected solution has a positive value.

If these two conditions are met, the visual indicator turns green. If a solution is not selected, the indicator turns white. If a solution is selected but the calculated volume has a negative value, the indicator turns red.

In FIG. 4, the volumes Vb, Vp and V1 have a value of 3.65099 L, 0.984067 L and 2.30741 L, respectively. The three corresponding solutions Sb, Sp, and P1 were selected in the combination for the manufacture of the phosphoric acid solution, and their values are positive: The indicator turns green.

In the lower part of FIG. 4, there are switches Ib, Ip, I1, I2 and If for each of the solutions Sb, Sp, P1, P2 and Sf. If a switch is activated by the user, the corresponding solution could potentially be selected in a combination to make the phosphoric acid solution. If said switch is not activated, said solution will not be taken into account, and can therefore not be selected.

In FIG. 4, all the switches are activated: The solutions Sb, Sp, P1, P2, and Sf can all potentially be chosen in a combination to make the phosphoric acid solution.

In reference to FIG. 4, a volume V2 is fixed for the solution P2 at 1.475 L, and a volume Vf for the solution Sf at 1.58254 L.

The computer has determined that to prepare 10 L of a phosphoric acid solution with a P₂O₅ content of 42% and a Cd content of 7%, it is possible to mix:
3.65099 L of solution Sb;
0.984067 L of solution Sp;
2.30741 L of solution P1.

### Example 2

The same membrane filtration steps are carried out as in Example 1, and the same application is used.

As in Example 1, it is desired to prepare 10 L of a phosphoric acid solution with a P₂O₅ content of 42% and a Cd content of 7%, as illustrated in FIG. 5.

A volume V2 is fixed for the solution P2 at 0.456187 and a volume Vf for the solution Sf at 5.18129.

In reference to FIG. 5, the computer determined that to prepare the desired phosphoric acid solution, it is possible to mix:
0.399327 L of solution Sb;
2.52569 L of solution Sp;
1.43751 L of solution P1.

In the two preceding examples, by means of the method of the invention, the user knows which solutions they must mix and in what proportions to prepare the phosphoric acid solution having the desired contents of P₂O₅ and Cd, without having to perform long and tedious calculations which can be a source of error.

They can then make the mixture, and obtain the phosphoric acid solution suitable for specific applications and complying with the requirements applicable in the field in question.

### Example 3

The test is carried out under the same conditions as in Example 1. The crude acid Sb and clarified acid Sp used in this method contain a high content of Cd: 40 ppm and 37 ppm, respectively.

The increase in the concentration of cadmium in phosphoric acid has no influence on the reduction of Cd, the total reduction of which is greater than 99%. Increasing the cadmium concentration does not change the selectivity of the nanofiltration membrane.

The same grade (10 L) of phosphoric acid as that of Example 1 was obtained. This confirms that whatever the profile of the starting acid, the invention makes it possible to obtain the desired grade.

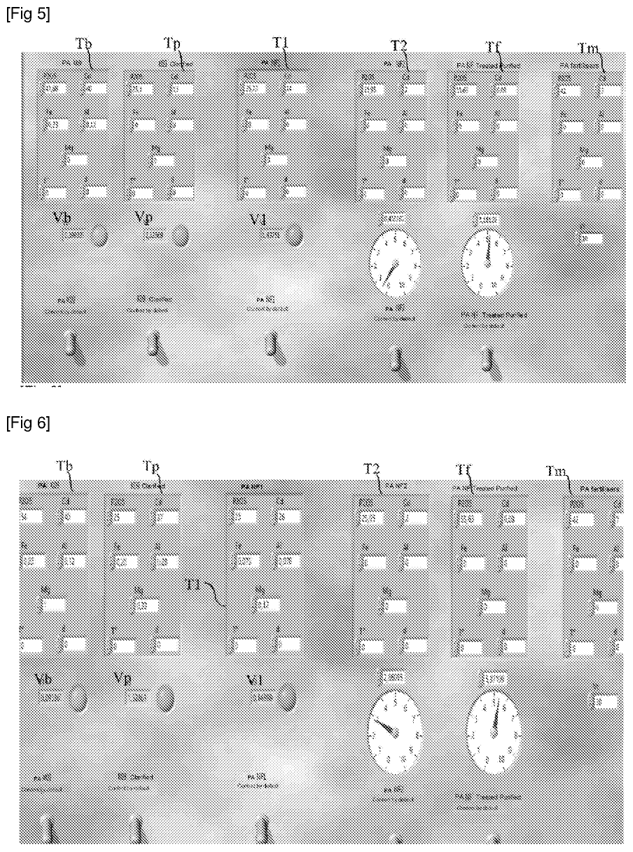

In reference to FIG. 6, a volume V2 is fixed for the solution P2 at 2.86095 L, and a volume Vf for the solution Sf at 5.37109 L.

In reference to FIG. 6, the computer determined that to prepare the desired phosphoric acid solution, it is possible to mix:
0.09536 L of solution Sb;
1.52861 L of solution Sp;
0.14398 L of solution P1.

1. A method for determining mixing parameters for preparing a phosphoric acid solution comprising a controlled content of at least one of its chemical constituents, referred to as the solution to be prepared, said solution to be prepared being obtained by mixing at least two preliminary phosphoric acid solutions, said method comprising:
providing the at least two preliminary solutions such that each preliminary solution has a different content of said chemical constituent, at least one of said preliminary solutions being a permeate resulting from the filtration of a crude phosphoric acid solution through at least one nanofiltration membrane,
providing a desired content of said chemical constituent in the phosphoric acid solution to be prepared, and a desired volume of said phosphoric acid solution to be prepared; determining using a computer, from the desired content (Tₘ) and the desired volume:
at least one combination of at least two preliminary phosphoric acid solutions among a plurality of phosphoric acid solutions to be mixed, and
a volume of each of said preliminary phosphoric acid solutions to be mixed of the combination, such that the mixing of the preliminary phosphoric acid solutions of the combination leads to the phosphoric acid solution to be prepared.

2. The method according to claim 1, further comprising the provision of the desired volume of at least one preliminary phosphoric acid solution to be mixed, separate from the solution to be prepared, the computer determination of the combination of preliminary phosphoric acid solutions to be mixed and their volume being made from said desired volume of said phosphoric acid to be prepared.

3. The method according to claim 1, further comprising mixing the preliminary solutions of the computer-determined combination to obtain the phosphoric acid solution to be prepared.

4. The method according to any claim 1, wherein mixing the preliminary phosphoric acid solutions to be mixed comprises the mixing of at least three preliminary phosphoric acid solutions, at least two of said preliminary solutions being permeates resulting from the filtration of the crude phosphoric acid solution through at least two nanofiltration membranes of a filtration cascade.

5. The method according to claim 1, further comprising measuring a content of said chemical constituent in the phosphoric acid solution to be prepared and the volume of said phosphoric acid solution to be prepared.

6. The method according to claim 1, wherein said chemical constituent is selected from one or more of the following chemical constituents: P₂O₅, Cd, Na, Ca, Mg, Al, Cu, Fe, Zn, Mn, Si, Co, V, Ni and Cr.

7. The method according to claim 1, wherein at least one nanofiltration membrane is an organic membrane on which is adsorbed at least one water-soluble polymer comprising at least one amine function, one aromatic amine function, one acid function and/or one alcohol function.

8. The method according to claim 7, wherein the adsorbed water-soluble polymer has a molar mass comprised between 100 g/mol and 40,000 g/mol.

9. A system for determining mixing parameters for the preparation of a phosphoric acid solution comprising a controlled content of at least one of its chemical constituents, referred to as the solution to be prepared, said solution to be prepared being obtained by mixing at least two preliminary phosphoric acid solutions, referred to as the preliminary solutions to be mixed, each having a different content of said chemical constituent, at least one of said preliminary solutions being a permeate resulting from the filtration of a crude phosphoric acid solution through at least one nanofiltration membrane, comprising:
a user interface;
a computer comprising at least one processor, coupled to said user interface, the user interface being configured to allow a user to enter a desired content of said chemical constituent in the phosphoric acid solution to be prepared, and a desired volume of said phosphoric acid solution to be prepared, the computer being configured, from the desired content and the desired volume, to determine:
at least one combination of at least two phosphoric acid solutions among the preliminary phosphoric acid solutions to be mixed;
volumes of each of said preliminary phosphoric acid solutions to be mixed of the combination, such that the mixing of the preliminary phosphoric acid solutions of the combination leads to the phosphoric acid solution to be prepared, the user interface being further configured to display said combination and said volumes to be mixed as determined by the computer.
